(19) United States
(12) Patent Application Publication
(10) Pub. No.: US 2026/0084094 A1
(43) Pub. Date: Mar. 26, 2026

(54) PLANT AND METHOD FOR PRODUCING CARBON DIOXIDE

(71) Applicant: Siemens Energy Global GmbH & Co. KG, München (DE)

(72) Inventors: Lukas Biyikli, Ratingen (DE); Suhel Ahmad, Duisburg (DE)

(21) Appl. No.: 19/110,877

(22) PCT Filed: Sep. 5, 2023
(86) PCT No.: PCT/EP2023/074282

§ 371 Date: Mar. 12, 2025

(30) Foreign Application Priority Data
Sep. 22, 2022 (DE) 10 2022 210 002.6

(51) Int. Cl. B01D 53/14; B01D 53/18; B01D 53/26; B01D 53/28; B01D 53/62; B01D 53/73; B01D 53/78; C01B 32/50

(52) U.S. Cl. CPC B01D 53/1475; B01D 53/1418; B01D 53/18; B01D 53/263; B01D 53/28; B01D 53/62; B01D 53/73; B01D 53/78; C01B 32/50; B01D 2252/2025; B01D 2257/504; B01D 2257/80; B01D 2258/0283

(57) ABSTRACT

The invention pertains to a plant for producing carbon dioxide (CO2), featuring a separation system connected to a gas mixture of flue gas and CO2. This system separates CO2 from the flue gas and operates with steam from a steam line. A first CO2 line, connected to the separation system, directs the separated CO2 through a preheater, increasing its temperature. A multi-stage compressor, linked to the preheater, raises the CO2's temperature and pressure. After one stage, CO2 passes through a steam generator, where its thermal energy generates steam from water. The cooled CO2 is recirculated to the compressor's next stage. The steam produced is connected back to the separation system via the steam line. Finally, CO2 exiting the compressor's last stage is reheated in the preheater and directed into an outlet line.

### BACKGROUND

The invention relates to a plant and to a method for operating a plant.

The invention relates in particular to a plant and to a method for capturing and processing carbon dioxide (CO₂) for transport in a pipeline.

It is known that carbon dioxide (CO₂) emissions from the operation of power plants and other processes must be reduced. Carbon capture is regarded here as an important factor in achieving the worldwide goal of lowering CO₂ emissions to as low a level as possible.

The International Energy Agency (IEA) predicts that the amount of CO₂ captured may rise from the 50 million tonnes per year of today to 7600 million tonnes per year by 2050 in order to meet climate goals.

In order to capture the carbon dioxide (CO₂) from exhaust gas, for example in a flue gas, the only technology currently commercially available on a large scale is the amine system. Amine systems require considerable amounts of low-pressure steam and thus heat for the process and are quite cost-intensive, which often makes carbon capture seem economically unattractive to operators.

Another aspect is that, after sequestration, the carbon dioxide (CO₂) usually has to be transported over long distances if there is no nearby storage or utilization. For this purpose, pipeline transport in the supercritical phase is often considered to be a good approach. Bringing the carbon dioxide (CO₂) into the supercritical phase requires compression thereof from near-atmospheric pressure to supercritical pressure (above 73 bar and 31° C.), typically between 100 and 200 bar.

The compression involves the release of a considerable amount of heat that, at present, remains unused because of the low temperature level.

There are different potential heat sources depending on the method according to which the amine system is used. Some processes are exothermic, meaning that waste heat streams can be used for LP steam production. However, if this is not the case and there is no alternative heat source, a fuel-fired or electrically fired boiler must be installed. Commonly used are natural gas boilers, which consume large amounts of gas and also produce additional carbon dioxide (CO₂), which also has to be captured and thus means even higher energy and investment requirements for the amine system.

With respect to the heat of compression, it should be used sensibly and possibly combined with the LP steam production required for the amine system. However, the low-quality heat must first be converted into high-quality heat. One possible approach is to use fewer intercoolers between the compression stages, such that the carbon dioxide (CO₂) is not cooled until it is above the temperature at which the heat can be used for LP steam production. However, the carbon dioxide (CO₂) is then cooled back to atmospheric temperature, and so the amount of steam that can be generated is comparatively small and the heat is only partially used. If the heat is to be used to an extent of 100% and steam production maximized, a high-temperature heat pump can be used. However, this is associated with distinctly higher investment costs and space requirements.

### SUMMARY

Against this background, it is an object of the invention to provide a plant and a method for providing carbon dioxide (CO₂) at optimal cost.

It is a further object of the invention to maximize heat recovery for low-pressure (LP) steam production while minimizing costs and space requirements.

This object is achieved by a plant for providing carbon dioxide (CO₂) comprising a separation system, the separation system being in flow connection with a gas mixture composed of flue gas and carbon dioxide (CO₂), the separation system being designed such that the carbon dioxide (CO₂) in the flue gas is separated, wherein during operation the separation system is operable with steam from a steam line, further comprising a first carbon dioxide line which is in flow connection with the separation system and from which the carbon dioxide (CO₂) separated in the separation system flows during operation, further comprising a preheater through which the carbon dioxide line passes and which is designed such that the temperature of the carbon dioxide (CO₂) is increased, further comprising a multistage compressor which, on the inlet side, is in flow connection with the carbon dioxide line coming out of the preheater, wherein after one stage the temperature and the pressure of the carbon dioxide (CO₂) is increased, wherein after the stage the carbon dioxide (CO₂) passes via a line through a steam generator, wherein the steam generator is designed such that steam is generated from water delivered into the steam generator by means of energy exchange with the thermal energy of the carbon dioxide (CO₂) coming out of the compressor after one stage, wherein the carbon dioxide (CO₂) cooled in the steam generator is recirculated into the compressor toward a next stage, wherein the steam generated in the steam generator is in flow connection with the separation system via the steam line, wherein the carbon dioxide (CO₂) flowing out of the compressor after the last stage flows through the preheater and is heated and flows into an outlet line.

The object directed to the method is achieved by the steps of: effecting flow delivery of a gas mixture composed of flue gas and carbon dioxide (CO2) into a separation system; separating the carbon dioxide (CO₂) in the separation system; delivering the carbon dioxide (CO₂) to a preheater, the carbon dioxide (CO₂) being heated in the preheater; transferring the carbon dioxide (CO₂) heated in the preheater to a first stage of a multistage compressor, the pressure and the temperature of the carbon dioxide (CO₂) being increased in the first stage; transferring the heated carbon dioxide (CO₂) to a steam generator after the first stage, the thermal energy of the carbon dioxide (CO₂) being used to generate steam in the steam generator; carrying out a recirculating step, the recirculating step comprising passing the carbon dioxide (CO₂) cooled in the steam generator to a further stage of the compressor, the further stage comprising increasing the temperature and the pressure of the carbon dioxide (CO₂); transferring the heated carbon dioxide (CO₂) to the steam generator after the further stage, the thermal energy of the carbon dioxide (CO₂) being used to generate steam in the steam generator; repeating the recirculating step up to a last stage, transferring through the preheater the carbon dioxide which flows out after the last stage; and transferring into an outlet line the carbon dioxide which flows out of the preheater, wherein the steam generated in the steam generator is in flow connection with the separation system via the steam line.

The new solution makes it possible to maximize heat utilization and to generate the same amount of steam as with a heat pump while requiring virtually no additional equipment and space.

An essential feature of the invention is the compressor, which typically comprises six to eight stages for compression from atmospheric pressure to supercritical pressure. This means that the process of compression and steam production in the heat recovery steam generator (HRSG) actually proceeds multiple times, depending on the final number of stages required to reach the outlet pressure.

The preheater and all other downstream components are used only once, irrespective of the number of stages.

According to the invention, the carbon dioxide (CO₂) is cooled only to such an extent that the heat can still be used for steam production in the heat recovery steam generator. This temperature is generally 5-10° C. above the final temperature of the steam required for the amine system, but this depends on the final design of the heat exchanger. However, this means that the carbon dioxide (CO₂) is not cooled back to atmospheric temperature before passing into the next compressor stage. This allows steam production after each compression stage with the same number of heat exchangers/HRSGs as in conventional operation.

In actual fact, however, this process may start only after the second or even third stage of the compressor, since the carbon dioxide (CO₂) must first be heated from the atmospheric outlet temperature after the amine system to the usable temperature level. In order to further maximize steam production, the high temperature of the carbon dioxide (CO₂) after the last HRSG can, then, be used to preheat the carbon dioxide (CO₂) at the compressor inlet to the usable temperature level, which means that the entire compressor from the extraction point to the outlet is operated at the temperature level at which steam can be produced, which means that steam production can already start after the first compressor stage.

Downstream of the preheater, an aftercooler is still necessary in order to cool the carbon dioxide (CO₂) back to atmospheric temperature, even though it has already partially cooled in order to preheat the carbon dioxide (CO₂) at the inlet. Furthermore, pipeline injection frequently requires dewatering of the carbon dioxide (CO₂) stream, which is generally done at a pressure of 40-50 bar with a triethylene glycol (TEG) system, since this is the most economical type of carbon dioxide (CO₂) dewatering. However, this would mean that the carbon dioxide (CO₂) would have to be cooled back to atmospheric temperature for dehydration at 40-50 bar.

This problem is solved by the use of a glycerol-based dehydration system, which is somewhat more expensive and energy-intensive, but allows the dehydration of carbon dioxide (CO₂) at supercritical pressure and thus the maximization of steam production. However, if this is not desired for any reason, the carbon dioxide (CO₂) can also be dehydrated at 40-50 bar with a TEG system. In this case, it is necessary to adjust the preheaters and heat exchangers.

According to the invention, additional equipment or machines are not necessary, and also the additional space requirements are very limited, whereas a heat pump would approximately double the space requirements and the investment costs. Therefore, the solution considerably reduces the energy demand of the amine system, which leads to fuel economy, and also to a reduction in carbon dioxide (CO₂) if a fossil fuel is used, and therefore in this context, also to a reduction in the CAPEX of the amine system, since less carbon dioxide (CO₂) has to be captured, while no additional machines and only a little extra power are required.

Furthermore, the demand for cooling water for the compressor is considerably reduced, since, apart from the aftercooler, feed water or the carbon dioxide (CO₂) from the inlet is always used to cool the carbon dioxide (CO₂), which can also be a considerable advantage, since it is a problem in some regions to provide cooling water.

Advantageous developments are specified in the dependent claims.

The advantage of the invention is the maximization of the heat utilization and recovering of the carbon dioxide (CO₂) heat of compression virtually without additional machines and space requirements.

Another advantage is the fuel economy in the boiler for the LP steam production for the amine system.

A further advantage is the significant reduction in cooling water for the carbon dioxide (CO₂) compressor.

Another advantage is achieved by the potential reduction in carbon dioxide (CO₂) if a fossil fuel is used as the heat source for the boiler.

The above-described properties, features and advantages of this invention and the manner in which they are achieved will become more clearly and distinctly apparent in conjunction with the description of the working examples that follows, and these are elucidated in detail in conjunction with the drawings.

### BRIEF DESCRIPTION OF THE DRAWINGS

In that context, identical components or components having identical functions are labelled with identical reference signs.

Working examples of the invention will be described hereinafter with reference to the drawings. These are not intended to illustrate the working examples to scale; instead, the drawing, where conducive to clarification, is constructed in a schematized and/or slightly distorted form. With regard to additions to the teachings which are directly apparent in the drawing, reference is made to the relevant prior art.

The figures show:

FIG. 1 a schematic diagram of one embodiment of a plant of the invention; and

FIG. 2 a schematic diagram of an alternative embodiment of a plant of the invention.

### DETAILED DESCRIPTION

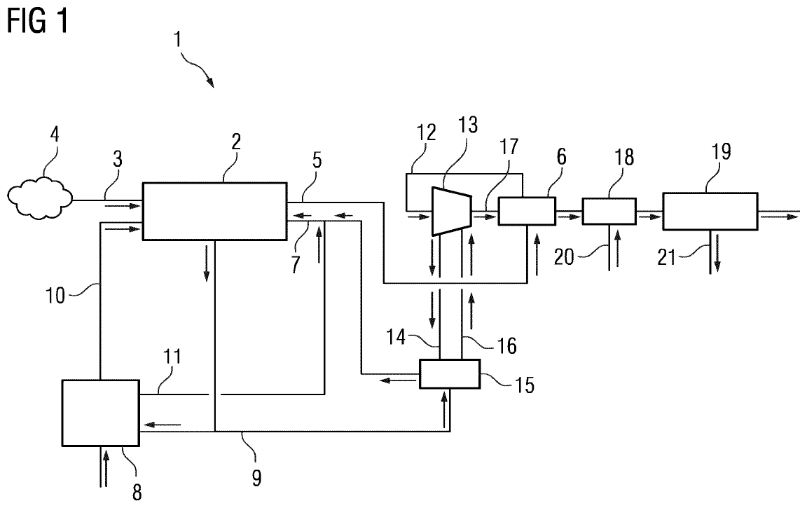

FIG. 1 shows a schematic diagram of one embodiment of an plant 1 in accordance with an embodiment.

The plant 1 is designed to provide carbon dioxide (CO₂) and comprises a separation system 2. The separation system 2 is in flow connection with a gas mixture 4 composed of flue gas and carbon dioxide (CO₂) via a line 3. The separation system 2 is designed such that the carbon dioxide (CO₂) in the flue gas 4 is separated. The separated carbon dioxide (CO₂) flows via a first carbon dioxide line 5 out of the separation system 2 through a preheater 6. In the preheater 6, the temperature of the carbon dioxide (CO₂) is increased.

The first carbon dioxide line 5 is in flow connection with the separation system 2. The separation system 2 here is designed as an amine system.

During operation, the separation system 2 is operated with steam from a steam line 7. The carbon dioxide (CO₂) generated in the boiler 8 is also optionally delivered into the separation system 2 via a line 10. The steam produced in the boiler 8 is passed into the separation system 2 via a line 11.

The carbon dioxide (CO₂) heated after the preheater 6 is delivered to a multistage compressor 13 via a line 12. The multistage compressor 13 is, on the inlet side, in flow connection with the carbon dioxide line 5 coming out of the preheater 6.

In the compressor 13, the heated carbon dioxide (CO₂) is delivered to a first stage, and in the first stage the temperature and the pressure of the carbon dioxide are increased.

After the first stage, the carbon dioxide (CO₂) is delivered to a steam generator 15, which may be in the form of an HRSG (heat recovery steam generator), via a line 14.

The steam generator 15 is designed such that a water delivered into the steam generator 15 is converted into steam by means of energy exchange with the thermal energy of the carbon dioxide (CO₂) coming out of the compressor 13 after one stage.

The compressor 13 has five to ten stages, more particularly six to nine stages and most particularly seven or eight stages.

The carbon dioxide (CO₂) cooled in the steam generator 15 is recirculated into the compressor 13 via a line 16 toward a next stage. There, the carbon dioxide (CO₂) is delivered to a next stage, and from there it is redelivered to the steam generator 15. This happens multiple times, i.e., there are multiple stages of flow passing through the compressor 13, each stage being followed by using the thermal energy of the carbon dioxide (CO₂) to produce steam in the steam generator 15. For the sake of clarity, FIG. 1 shows only one line 14 to the steam generator 15 and one line 16 from the steam generator 15 to the compressor 13. For the sake of clarity, the individual lines to the steam generator 15 and back to the compressor 13 were not shown.

The steam generated in the steam generator 15 is in flow connection with the separation system 2 via the steam line 7.

The carbon dioxide (CO₂) flowing out of the compressor 13 after a last stage flows via a line 17 through the preheater 6.

Thereafter, the carbon dioxide (CO₂) flows into an aftercooler 18, the aftercooler 18 being designed such that the temperature of the carbon dioxide (CO₂) coming out of the preheater 6 is reduced. The aftercooler 18 is supplied with cooling water 20.

Downstream of the aftercooler 18, the carbon dioxide (CO₂) flows through a dewatering unit (glycerol) 19, the dewatering unit 19 being designed to dewater the carbon dioxide (CO₂) coming out of the preheater 6. The water separated in the dewatering unit 19 is discharged via a dewatering line 21.

The aftercooler 18 is in flow connection with cooling water via a cooling water line 20.

The carbon dioxide (CO₂) generated and provided in the plant 1 is then processed for transport in a pipeline.

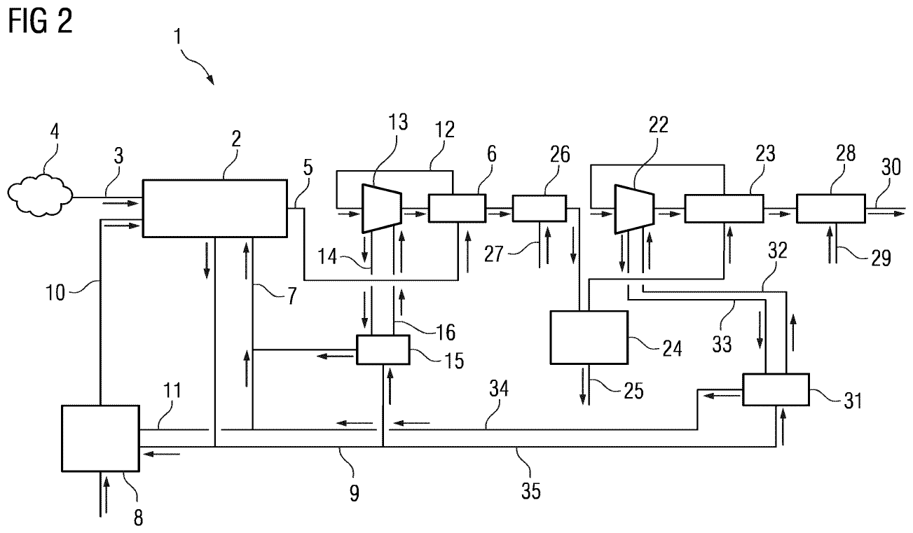

FIG. 2 shows a schematic diagram of an alternative embodiment of an plant 1 for providing carbon dioxide (CO₂). The separation process in the separation system 2 by means of the compressor 13 is identical to the embodiment according to FIG. 1. Reference is therefore made to the above description in relation to FIG. 1.

One difference in relation to the plant according to FIG. 1 is, for example, that between the preheater 6 and the aftercooler 18 is a further compressor 22 which is in flow connection downstream of a superheater 23. The superheater 23 in turn is in flow connection with a dewatering system 24, which may be designed as a TEG system. Flowing out of the dewatering system 24 is separated water 25.

Between the preheater 6 and the dewatering system 24 is a cooler 26 which is supplied with water 27.

In a similar way to the compressor 13, the further compressor 22 is in flow connection with the steam generator 31. As described for the compressor 13, the carbon dioxide (CO₂) is also delivered to the steam generator 31 after each stage in the case of the further compressor 22.

The carbon dioxide (CO₂) cooled in the steam generator 31 is recirculated into the further compressor 22 via a line 32 toward a next stage of the further compressor 22. There, the carbon dioxide (CO₂) is delivered to a next stage, and from there it is redelivered to the steam generator 31. This happens multiple times, i.e., there are multiple stages of flow passing through the further compressor 22, each stage being followed by using the thermal energy of the carbon dioxide (CO₂) to produce steam in the steam generator 31. For the sake of clarity, FIG. 2 shows only one line 33 to the steam generator 31 and one line 32 from the steam generator 31 to the compressor 22. For the sake of clarity, the individual lines to the steam generator 31 and back to the further compressor 22 were not shown.

The steam generated in the steam generator 31 is in flow connection with the steam line 7 and thus with the separation system 2 via the steam line 34.

The carbon dioxide (CO₂) flowing out of the further compressor 22 after a last stage flows via a line through the superheater 23.

The steam generator 31 is in flow connection with the line 9 via a line 35.

Downstream of the superheater 23 is an aftercooler 28 which is also supplied with water 29 as coolant. The carbon dioxide (CO₂) generated and provided in the plant 1 is then processed for transport in a pipeline 30.

1. A plant for providing carbon dioxide (CO₂) comprising:
a separation system, the separation system being in flow connection with a gas mixture composed of flue gas and carbon dioxide (CO₂), the separation system being designed such that the carbon dioxide (CO₂) in the flue gas is separated,
wherein during operation the separation system is operable with steam from a steam line;
a first carbon dioxide line which is in flow connection with the separation system and from which the carbon dioxide (CO₂) separated in the separation system flows during operation;
a preheater through which the carbon dioxide line passes and is designed such that a temperature of the carbon dioxide (CO₂) is increased; and
a multistage compressor which, on an inlet side, is in flow connection with the carbon dioxide line coming out of the preheater,
wherein after one stage the temperature and a pressure of the carbon dioxide (CO₂) is increased,
wherein after the stage the carbon dioxide (CO₂) passes via a line (14) through a steam generator,
wherein the steam generator is designed such that steam is generated a water delivered into the steam generator by means of energy exchange with a thermal energy of the carbon dioxide (CO₂) coming out of the compressor after one stage,
wherein the carbon dioxide cooled in the steam generator is recirculated into the compressor toward a next stage,
wherein the steam generated in the steam generator is in flow connection with the separation system via the steam line, and
wherein the carbon dioxide (CO₂) flowing out of the compressor after the last stage flows through the preheater and is heated and flows into an outlet line.

2. The plant as claimed in claim 1,
wherein the carbon dioxide (CO₂) generated in the plant is processed for transport in a pipeline.

3. The plant as claimed in claim 1,
wherein the separation system is designed as an amine system.

4. The plant as claimed in claim 1,
wherein the compressor has five to ten stages, more particularly six to nine stages and most particularly seven or eight stages.

5. The plant as claimed in claim 1,
wherein downstream of the preheater is an aftercooler, the aftercooler being designed such that the temperature of the carbon dioxide (CO₂) coming out of the preheater is reduced.

6. The plant as claimed in claim 5,
wherein downstream of the preheater is a dewatering unit, the dewatering unit being designed to dewater the carbon dioxide (CO₂) coming out of the preheater.

7. The plant as claimed in claim 6,
wherein the dewatering unit is downstream of the aftercooler.

8. The plant as claimed in claim 1,
wherein between the compressor and the preheater is a further compressor, the compressor and the further compressor being in flow connection with one another.

9. The plant as claimed in claim 8,
wherein between the compressor and the further compressor is a cooler, an outlet of the compressor being in flow connection with an inlet of the cooler, and an outlet of the cooler being in flow connection with an inlet of the further compressor.

10. The plant as claimed in claim 9,
wherein between the cooler and the further compressor is a dewatering system, an outlet of the cooler being in connection with an inlet of the dewatering system, and an outlet of the dewatering system being in flow connection with an inlet of the further compressor.

11. The plant as claimed in claim 10,
wherein the dewatering system is designed as a triethylene glycol (TEG) system.

12. A method for providing carbon dioxide (CO₂),
comprising the steps of:
effecting flow delivery of a gas mixture composed of flue gas and carbon dioxide (CO₂) into a separation system;
separating the carbon dioxide (CO₂) in the separation system;
delivering the carbon dioxide (CO₂) to a preheater, the carbon dioxide (CO₂) being heated in the preheater;
transferring the carbon dioxide (CO₂) heated in the preheater to a first stage of a multistage compressor, a pressure and a temperature of the carbon dioxide (CO₂) being increased in the first stage;
transferring the heated carbon dioxide (CO₂) to a steam generator after the first stage, a thermal energy of the carbon dioxide (CO₂) being used to generate steam in the steam generator;
carrying out a recirculating step, the recirculating step comprising passing the carbon dioxide (CO₂) cooled in the steam generator to a further stage of the compressor, the further stage comprising increasing the temperature and the pressure of the carbon dioxide (CO₂);
transferring the heated carbon dioxide (CO₂) to the steam generator after the further stage, the thermal energy of the carbon dioxide (CO₂) being used to generate steam in the steam generator;
repeating the recirculating step up to a last stage;
transferring through the preheater the carbon dioxide (CO₂) which flows out after the last stage; and
transferring into an outlet line the carbon dioxide (CO₂) which flows out of the preheater,
wherein the steam generated in the steam generator is in flow connection with the separation system via the steam line.

13. The method as claimed in claim 12,
wherein downstream of the preheater is an aftercooler, the aftercooler being designed to cool the carbon dioxide (CO₂) coming out of the preheater.

14. The method as claimed in claim 13,
wherein downstream of the aftercooler is a dewatering unit.

15. The method as claimed in claim 12,
wherein between the compressor and the preheater is a further compressor.

16. The method as claimed in claim 15,
wherein between the compressor and the further compressor is a cooler.

17. The method as claimed in claim 16,
wherein between the cooler and an overheater is a dewatering unit.

18. The method as claimed in claim 17,
wherein the dewatering unit is designed as a triethylene glycol (TEG) system.
